(19) United States
(12) Patent Application Publication
(10) Pub. No.: US 2025/0299662 A1
(43) Pub. Date: Sep. 25, 2025

(54) ACOUSTIC CONTROL DEVICE

(71) Applicants: KABUSHIKI KAISHA TOSHIBA, Tokyo (JP); TOSHIBA DIGITAL SOLUTIONS CORPORATION, Kawasaki-shi Kanagawa (JP)

(72) Inventor: Yuki Yamada, Yokohama Kanagawa (JP)

(73) Assignees: KABUSHIKI KAISHA TOSHIBA, Tokyo (JP); TOSHIBA DIGITAL SOLUTIONS CORPORATION, Kawasaki-shi Kanagawa (JP)

(21) Appl. No.: 19/072,260

(22) Filed: Mar. 6, 2025

(30) Foreign Application Priority Data
Mar. 22, 2024 (JP) 2024-045954

(51) Int. Cl. G10K 11/175; H04S 7/00

(52) U.S. Cl. CPC G10K 11/1754; H04S 7/302; H04S 2400/11

(57) ABSTRACT

An acoustic control device includes a processor including hardware. The processor acquires interference sound data containing information on an interference sound that serves as noise for interfering with hearing of a target sound to which a lister is listening. The processor performs acoustic processing for interfering with the hearing of the target sound on the acquired interference sound data. The processor reproduces, through an output device, the interference sound data on which the acoustic processing has been performed.

### CROSS-REFERENCE TO RELATED APPLICATION(S)

This application is based upon and claims the benefit of priority from prior Japanese Patent Application No. 2024-045954, filed Mar. 22, 2024, the entire contents of which are incorporated herein by reference.

### FIELD

Embodiments described herein relate generally to an acoustic control device.

### BACKGROUND

As a technique for hindering hearing of a specific sound, a technique is known of reproducing a masking sound different from a specific sound in a space surrounding a sound source that is reproducing the specific sound. Reproduction of such a masking sound makes it difficult for a third party to listen to a specific target sound.

Reproduction of a masking sound is primarily used to prevent third parties from listening to a sound. On the other hand, in recent years, there have been many cases of sounds from mobile phones instructing users to commit acts of fraud or instructing erroneous actions such as transferring money to a criminal's account or purchasing a prepaid card as part of a fraudulent scheme. It is desirable for a sound that leads to such fraud to be difficult to hear even by a listener who is listening to sounds in real time from a mobile phone. As described above, appropriate control of the audibility of a sound that is heard in real time through some kind of output device enables use of sounds with higher security and efficiency.

### BRIEF DESCRIPTION OF THE DRAWINGS

FIG. 1 is a functional block diagram showing a configuration of an acoustic control device according to each embodiment.

FIG. 2 is a diagram showing a hardware configuration of an example of an acoustic control device according to a first embodiment.

FIG. 3 is a flowchart showing an operation of the acoustic control device according to the first embodiment.

FIG. 4 is a diagram showing a hardware configuration of an example of an acoustic control device according to a second embodiment.

FIG. 5 is a flowchart showing an operation of the acoustic control device according to the second embodiment.

FIG. 6 is a diagram showing a state of a listener according to the second embodiment.

FIG. 7 is a flowchart showing an operation of an acoustic control device according to a third embodiment.

FIG. 8 is a diagram showing a state of a listener according to the third embodiment.

FIG. 9 is a flowchart showing an operation of an acoustic control device according to a fourth embodiment.

FIG. 10 is a diagram showing a state of a listener according to the fourth embodiment.

FIG. 11 is a flowchart showing an operation of an acoustic control device according to a fifth embodiment.

FIG. 12 is a diagram showing a state of a listener according to the fifth embodiment.

FIG. 13 is a diagram showing a modification of the fifth embodiment.

### DETAILED DESCRIPTION

In general, according to one embodiment, an acoustic control device includes a processor including hardware. The processor acquires interference sound data containing information on an interference sound that serves as noise for interfering with hearing of a target sound to which a lister is listening. The processor performs acoustic processing for interfering with the hearing of the target sound on the acquired interference sound data. The processor reproduces, through an output device, the interference sound data on which the acoustic processing has been performed.

Hereinafter, embodiments will be described with reference to the drawings.

### First Embodiment

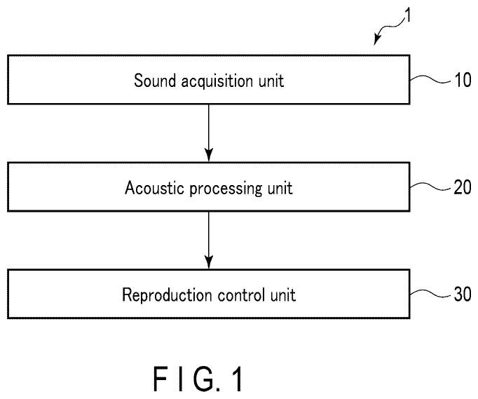

First, a first embodiment will be described. FIG. 1 is a functional block diagram showing a configuration of an acoustic control device according to each embodiment. As shown in FIG. 1, an acoustic control device 1 includes a sound acquisition unit 10, an acoustic processing unit 20, and a reproduction control unit 30. The acoustic control device 1 may be installed in various devices configured to emit sounds, such as sound guidance systems configured to provide various types of sound guidance to listeners in addition to various terminal devices such as mobile phones, smartphones, tablet terminals, etc., or may be installed in the vicinities of the aforementioned devices.

The sound acquisition unit 10 acquires sound data to be processed. The sound data includes interference sound data. The target sound data to be interfered with is data that contains information on a sound to which a listener is trying to listen in real time. The sound herein is often a human voice but is not necessarily limited to a human voice. The interference sound data is data that contains information on an interference sound that serves as noise for interfering with hearing of a target sound. Examples of the interference sound may include a masking sound such as a sound of a babbling brook, or meaningless sounds such as sounds of people bustling about and a voice reading numbers. Herein, it is desirable that the type and frequency band of the interference sound data have a common band with a target sound to be interfered with, and be not extremely unpleasant to humans. The frequency band may be adjusted by frequency band adjustment processing to be described later. The interference sound data may be stored in advance in a storage device (not shown) of the acoustic control device 1, for example, or may be generated in real time.

The acoustic processing unit 20 performs acoustic processing on sound data acquired by the sound acquisition unit 10. The acoustic processing contains, for example, volume adjustment processing and frequency band adjustment processing. The volume adjustment processing is processing for increasing or decreasing the volume of input sound data. The frequency band adjustment processing is processing that emphasizes or weakens a specific frequency band in input sound data. In particular, the audio processing unit 20 directs a listener's attention to an interference sound by performing the volume adjustment processing and the frequency band adjustment on the interference sound data, either alone or in combination. Meanwhile, the processing for directing a listener's attention to an interference sound is not limited to the volume adjustment processing and the frequency band adjustment processing.

The reproduction control unit 30 reproduces sound data processed by the acoustic processing unit 20, through a speaker serving as an acoustic reproduction unit. Herein, the reproduction control unit 30 may reproduce at least the interference sound data through the speaker.

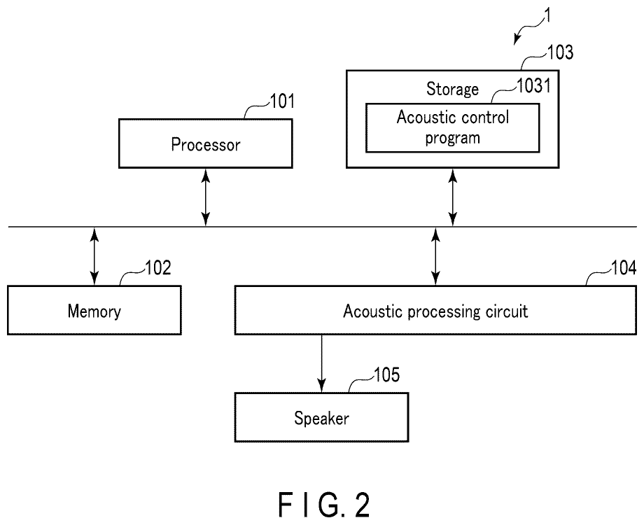

FIG. 2 is a diagram showing a hardware configuration of an example of the acoustic control device 1 according to the first embodiment. The acoustic control device 1 includes, for example, a processor 101, a memory 102, a storage 103, an acoustic processing circuit 104, and a speaker 105, as a hardware configuration. Herein, the acoustic control device 1 may have hardware elements other than those shown in FIG. 2. For example, the acoustic control device 1 may include a display device for displaying various images. The acoustic control device 1 may include a communication circuit for performing communications. The acoustic control device 1 may include an operation interface such as a button or a touch panel operated by a listener. The sound control device 1 may include a microphone for collecting sounds from an external sound source and a camera for acquiring external images.

The processor 101 is a processor configured to control an overall operation of the acoustic control device 1. The processor 101 operates as the sound acquisition unit 10 and the acoustic processing unit 20 by executing an acoustic control program 1031 stored in the storage 103, for example. The processor 101 is, for example, a CPU. The processor 101 may be an MPU, a GPU, an ASIC, an FPGA, etc. The processor 101 may be a single CPU, etc., or a plurality of CPUs. Furthermore, an operation of the processor 101 is not limited to the operation described herein.

The memory 102 contains a ROM and a RAM. The ROM is a nonvolatile memory region. The ROM stores a startup program, etc., for the acoustic control device 1. The RAM is a volatile memory. The RAM is used as a working memory for processing by the processor 101, for example.

The storage 103 is, for example, a storage such as a flash memory, a hard disk drive, or a solid state drive. The storage 103 stores various programs executed by the processor 101, such as the acoustic control program 1031. The storage 103 may also store the interference sound data.

The acoustic processing circuit 104 is a circuit configured to operate in cooperation with the processor 101 as the acoustic processing unit 20 and the reproduction control unit 30, and to perform acoustic processing on input sound data or to select sound data on which the acoustic processing has already been performed, thereby reproducing the aforementioned sound data through the speaker 105.

The speaker 105 is one or more speakers for reproducing the interference sound data.

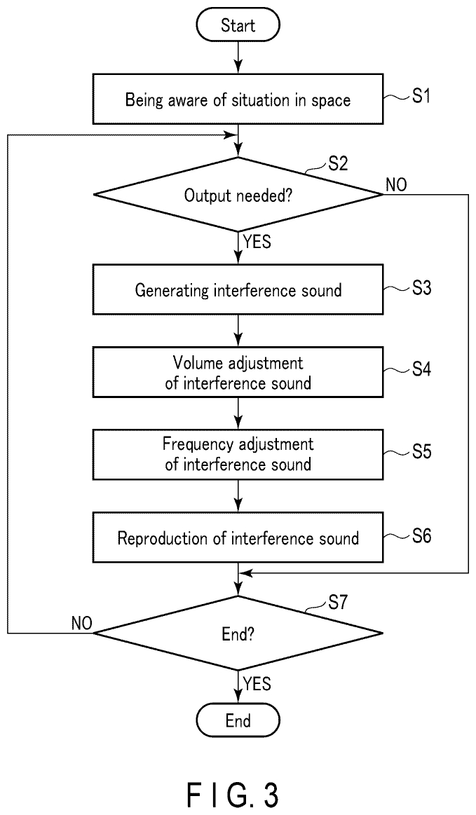

Next, the operation of the acoustic control device 1 according to the first embodiment will be described. FIG. 3 is a flowchart showing an operation of the acoustic control device 1 according to the first embodiment. The operation shown in FIG. 3 is controlled by the processor 101.

In step S1, a situation in the space containing the system concerned is recognized, and information for determination as to whether or not to output the interference sound is collected. A mechanism for implementing step S1 may be executed by the processor 101 contained in the system of the control device, or may be contained in a mechanism outside the system.

In step S2, the processor 101 determines whether output of the interference sound is necessary or not. In step S2, if it is not determined that output of the interference sound is necessary, the processing proceeds to step S7. In step S2, if it is determined that output of the interference sound is necessary, the processing proceeds to step S3.

In step S3, the processor 101 outputs the interference sound data to the acoustic processing circuit 104, performs the processing in steps S4 and S5 on the interference sound data, and instructs the acoustic processing circuit 104 to reproduce the interference sound data. In response to this, the acoustic processing circuit 104 reproduces target sound data through the speaker 105. This processing is performed in step S6. If the interference sound has already been generated and stored in the storage 103, etc., the processing in steps S3, S4, and S5 is omitted.

In step S4, the processor 101 outputs the interference sound data to the acoustic processing circuit 104. The processor 101 causes the acoustic processing circuit 104 to perform volume adjustment processing on the interference sound data. The acoustic processing circuit 104 performs, for example, processing of randomly increasing or decreasing the volume, as the volume adjustment processing with respect to the interference sound data. Humans easily recognize a sound whose volume changes randomly as an extraneous sound. Thus, a listener's attention can be directed to an interference sound by changing the volume of the interference sound. As a result, the listener becomes less aware of the target sound. In other words, it becomes difficult for the listener to listen to the target sound.

In step S5, the processor 101 causes the acoustic processing circuit 104 to perform the frequency band adjustment processing on the interference sound data. The acoustic processing circuit 104 performs, for example, processing of emphasizing a frequency band close to the target sound data, for example, as the frequency band adjustment processing with respect to the interference sound data. For example, if a target sound is a human voice, a frequency band of an interference sound is emphasized such that the interference sound becomes similar to the human voice, which is the target sound. Accordingly, a listener's attention can be directed to the interference sound. As a result, the listener becomes less aware of the target sound. In other words, it becomes difficult for the listener to listen to the target sound.

In step S6, the processor 101 instructs the acoustic processing circuit 104 to reproduce the interference sound data. In response to this, the acoustic processing circuit 104 reproduces the interference sound data through the speaker 105.

In step S7, the processor 101 determines whether or not to terminate the operation in FIG. 3. For example, if termination of the operation is instructed by a listener operating a button, etc., it is determined that the operation in FIG. 3 is to be terminated. In step S7, if it is not determined that the operation in FIG. 3 is to be terminated, the processor 101 returns the processing to step S2. If it is determined in step S7 that the operation in FIG. 3 is to be terminated, the processor 101 terminates the operation in FIG. 3.

As described above, according to the first embodiment, the acoustic processing to direct a listener's attention to an interference sound, that is, to make it difficult to listen to the target sound, is performed on an interference sound that is different from a target sound to which the listener is trying to listen. The target sound and the interference sound are then reproduced so that they can be heard simultaneously by the listener. By reproducing the interference sound on which such acoustic processing has been performed, hearing of the target sound to which a listener is trying to listen is hindered more effectively than the case in which the interference sound is simply reproduced.

Herein, in the example shown FIG. 3, both the volume adjustment processing and the frequency band adjustment processing are performed as the acoustic processing. In this respect, in FIG. 3, only one of the volume adjustment processing and the frequency band adjustment processing may be performed as the acoustic processing.

### Second Embodiment

Next, a second embodiment will be described. Herein, in the second embodiment, a description of similar parts to those in the first embodiment will be omitted. That is, the basic functional blocks shown in FIG. 1 are also applicable to the second embodiment. However, in the second embodiment, the acoustic processing unit 20 may perform sound image localization processing in addition to the volume adjustment processing and the frequency band adjustment processing. The sound image localization processing is processing for localizing a sound image in the space around a listener by using two-channel speakers. The sound image localization processing can give a listener the illusion that sound is coming from a direction different from the actual speaker direction. The specific sound image localization processing is processing in which two-channel sound data is generated by convolving a filter, which is calculated based on a head-related transfer function between a virtual sound source to which a listener is caused to listen and the positions of the listener's ears, with sound data. Sound image localization is achievable by reproducing the data sound convolved with such a filter, through two-channel speakers.

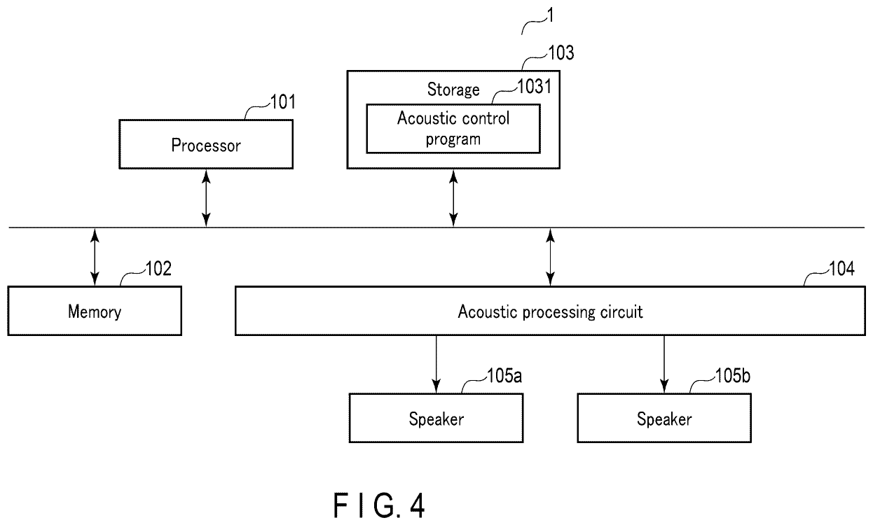

FIG. 4 is a diagram showing a hardware configuration of an example of the acoustic control device 1 according to the second embodiment. The acoustic control device 1 according to the second embodiment has, as a hardware configuration, for example, the processor 101, the memory 102, the storage 103, the acoustic processing circuit 104, and speakers 105a and 105b of two or more channels. Herein, as with the first embodiment, the acoustic control device 1 according to the second embodiment may have hardware elements other than those shown in FIG. 4.

The configurations of the processor 101, the memory 102, and the storage 103 may be similar to those in the first embodiment. Thus, a description thereof will be omitted.

The acoustic processing circuit 104 is a circuit configured to operate together with the processor 101 as the acoustic processing unit 20 and the reproduction control unit 30, to perform acoustic processing on input sound data, and to reproduce, through the speakers 105a and 105b, the sound data on which the acoustic processing has already been performed. The acoustic processing circuit 104 according to the second embodiment is configured to perform the sound image localization processing.

The speakers 105a and 105b are two-channel speakers for reproducing the interference sound data. For example, the speaker 105a may function as a left speaker located on the front left side of a listener, and the speaker 105a may function as a right speaker located on the front right side of the listener.

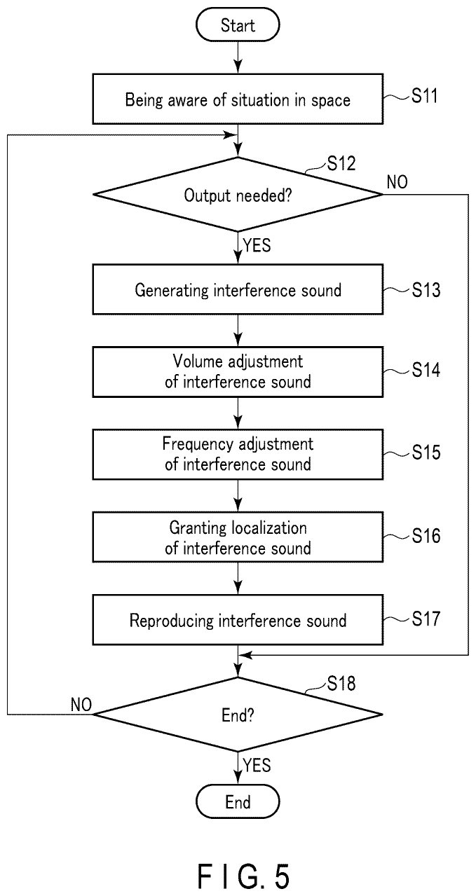

Next, the operation of the acoustic control device 1 according to the second embodiment will be described. FIG. 5 is a flowchart showing the operation of the acoustic control device 1 according to the second embodiment. The operation in FIG. 5 is controlled by the processor 101. In the description of FIG. 5, a description of the same processing steps as those in FIG. 3 will be omitted as appropriate.

In step S11, the processor 101 recognizes a situation in the space containing the system and collects information for determining whether or not to output the interference sound. A mechanism for implementing step S11 may or may not be contained in the system of the control device.

In step S12, the processor 101 determines whether output of the interference sound is necessary or not. In step S12, if it is not determined that output of the interference sound is necessary, the processing proceeds to step S18. In step S12, if it is determined that output of the interference sound is necessary, the processing proceeds to step S13.

In step S13, the processor 101 generates the interference sound data. For example, the processor 101 acquires the interference sound data from the storage 103.

In step S14, the processor 101 outputs the interference sound data to the acoustic processing circuit 104. The processor 101 causes the acoustic processing circuit 104 to perform volume adjustment processing on the interference sound data.

In step S15, the processor 101 causes the acoustic processing circuit 104 to perform the frequency band adjustment processing on the interference sound data.

In step S16, the processor 101 causes the acoustic processing circuit 104 to perform the sound image localization processing on the interference sound data. The acoustic processing circuit 104 generates interference sound data for an L channel (hereinafter referred to as “L channel interference sound data”) and interference sound data for an R channel (hereinafter referred to as “R channel interference sound data”) by applying a filter such that a sound which is equivalent to a sound in a case of a virtual sound source being placed at a predetermined position in the vicinity of a listener, for example at the left ear position of the listener, is reproduced from the speakers. In step S17, the acoustic processing circuit 104 reproduces the L channel interference sound data from the speaker 105a and also reproduces the R channel interference sound data from the speaker 105b.

In step S18, the processor 101 determines whether or not to terminate the operation in FIG. 5. In step S18, if it is not determined that the operation in FIG. 5 is to be terminated, the processor 101 returns the processing to step S12. If it is determined in step S19 that the operation in FIG. 5 is to be terminated, the processor 101 terminates the operation in FIG. 5.

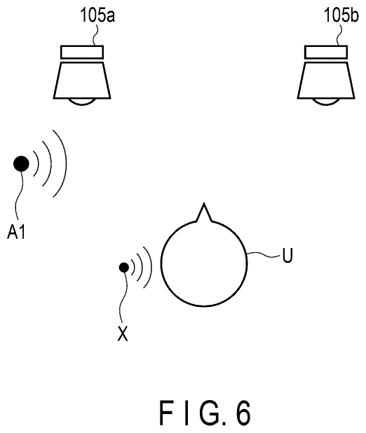

As described above, according to the second embodiment, the sound image localization processing is performed as processing to be performed on the interference sound. For example, as shown in FIG. 6, in the case of the presence of the speakers 105a and 105b emitting an interference sound on the left and right sides in front of a listener U, the listener U listens to the interference sound from the front while listening to a target sound from a target sound source X with his or her left ear. In this respect, by performing the sound image localization processing, the listener U may have the illusion that the interference sound is coming from a virtual sound source A1 at a position different from the original positions of the speakers 105a and 105b. As described above, the second embodiment realizes a state in which the interference sound is heard from directions containing a direction in which the interference sound does not naturally occur. This focuses a listener's attention on the interference sound, and as a result, improvement of an interference effect is expected.

Herein, the example shown in FIG. 5 performs both the volume adjustment processing and the frequency band adjustment processing in addition to the sound image localization processing, as the acoustic processing. In this respect, in FIG. 5, in addition to the sound image localization processing, only one of the volume adjustment processing and the frequency band adjustment processing may be performed as the acoustic processing, and it is not necessary to perform both of them. Furthermore, the interference sound data on which the sound image localization processing has been performed and the interference sound data on which the sound image localization processing has not been performed may be mixed and simultaneously played from the speakers 105a and 105b. In such a case, the listener U may have the illusion that the interference sound is coming from two directions.

### Third Embodiment

A third embodiment will be described. Herein, in the third embodiment, a description of similar parts to those in the first and second embodiments will be omitted. That is, the basic functional blocks shown in FIG. 1 are also applicable to the third embodiment. However, in the third embodiment also, the acoustic processing unit 20 may perform the sound image localization processing and phase adjustment processing in addition to the volume adjustment processing and the frequency band adjustment processing. The phase adjustment processing is processing for changing a phase of a sound. The hardware configuration shown in FIG. 4 is basically applicable to a hardware configuration of the acoustic control device 1 according to the third embodiment. However, the acoustic processing circuit 104 according to the third embodiment is configured to perform the phase adjustment processing.

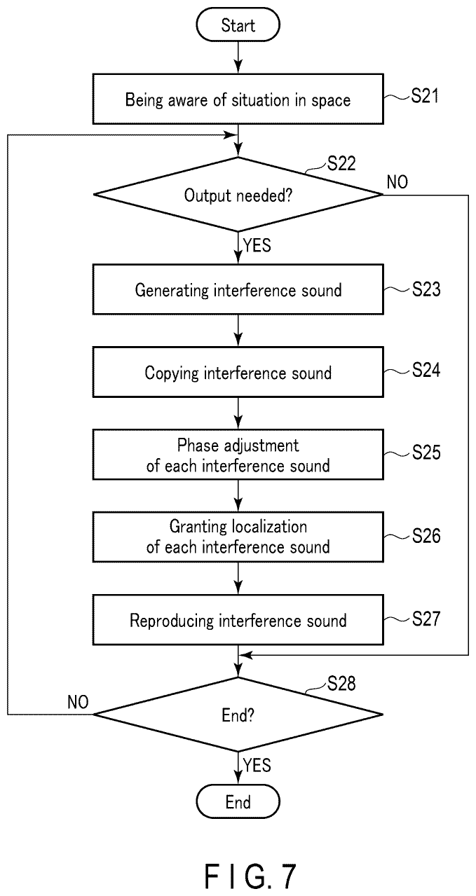

Next, the operation of the acoustic control device 1 according to the third embodiment will be described. FIG. 7 is a flowchart showing the operation of the acoustic control device 1 according to the third embodiment. The operation in FIG. 7 is controlled by the processor 101. In the description of FIG. 7, a description of the same processing steps as those in FIG. 3 or FIG. 5 will be omitted as appropriate.

In step S21, the processor 101 recognizes a situation in the space containing the system and collects information for determining whether or not to output the interference sound. A mechanism for implementing step S21 may or may not be contained in the system of the control device.

In step S22, the processor 101 determines whether output of the interference sound is necessary or not. In step S22, if it is not determined that output of the interference sound is necessary, the processing proceeds to step S28. In step S22, if it is determined that output of the interference sound is necessary, the processing proceeds to step S23. In step S23, the processor 101 generates the interference sound data. For example, the processor 101 acquires the interference sound data from the storage 103.

In step S24, the processor 101 makes a plurality of copies of the interference sound data. The number of copies of the interference sound data to be made may be a given number.

In step S25, the processor 101 outputs original interference sound data and copies of the interference sound data to the acoustic processing circuit 104. The processor 101 then causes the acoustic processing circuit 104 to perform the phase adjustment processing on each piece of the interference sound data. The acoustic processing circuit 104 imparts a different phase, i.e., a reproduction time delay, to each of the copies of the interference sound data. It is desirable that a phase difference imparted to each piece of the interference sound data be set such that the interference sounds that are heard virtually in a simultaneous manner by the listener do not simply sound like an echo.

In step S26, the processor 101 causes the acoustic processing circuit 104 to perform different sound image localization processing on each piece of the interference sound data. The acoustic processing circuit 104 generates the L channel interference sound data and the R channel interference sound data for each piece of the interference sound data such that the respective interference sounds are equivalent to a sound reproduced with virtual sound sources being placed at different positions. Herein, it is desirable that the positions of the virtual sound sources be appropriate positions that can be clearly recognized as being in different directions. In step S27, the sound processing circuit 104 mixes respective pieces of the L channel sound data for the L channel and reproduces the mixed data from the speaker 105a, and also reproduces respective pieces of the R channel interference sound data from the speaker 105b.

In step S28, the processor 101 determines whether or not to terminate the operation in FIG. 7. In step S28, if it is not determined that the operation in FIG. 7 is to be terminated, the processor 101 returns the processing to step S22. If it is determined in step S28 that the operation in FIG. 7 is to be terminated, the processor 101 terminates the operation in FIG. 7.

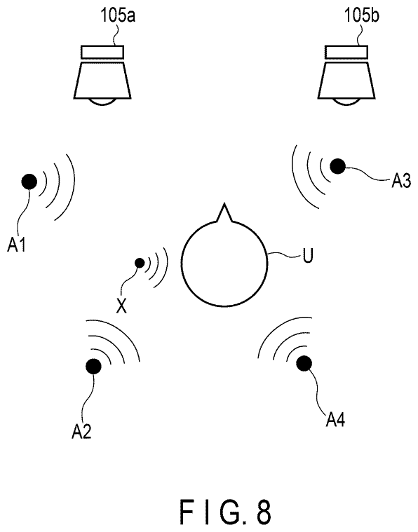

As described above, according to the third embodiment, the sound image localization processing for imparting different phases and for localization in different localization directions is performed on the plurality of pieces of interference sound data, as processing to be performed on the interference sound. As shown in FIG. 8, this leads to a state in which the listener U simultaneously listens to the interference sounds with slightly different reproduction timings from virtual sound sources A1, A2, A3, and A4 virtually arranged in different directions in the vicinity of the listener U. This brings the listener to a state in which he or she is surrounded by sounds that are extremely difficult to hear, so that the listener can be hindered from listening to the contents of the target sound from the target sound source X, to which the listener is originally trying to listen. Herein, in FIG. 8, there are four virtual sound sources. The number of virtual sound sources is not limited to four.

In the third embodiment, the volume adjustment processing and the frequency band adjustment processing may be performed on the respective pieces of interference sound data.

### Fourth Embodiment

Next, a fourth embodiment will be described. Herein, in the fourth embodiment, a description of similar parts to those in the first to third embodiments will be omitted. That is, the basic functional blocks shown in FIG. 1 are also applicable to the fourth embodiment. The hardware configuration shown in FIG. 4 is basically applicable to a hardware configuration of the acoustic control device 1 according to the fourth embodiment.

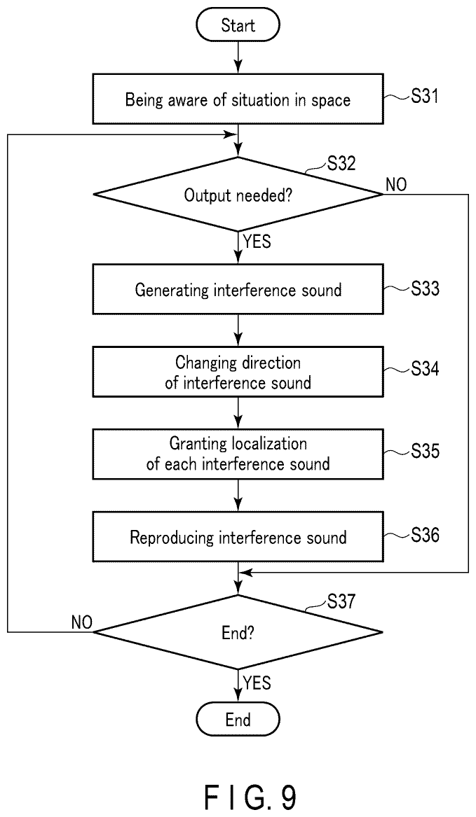

Next, the operation of the acoustic control device 1 according to the fourth embodiment will be described. FIG. 9 is a flowchart showing an operation of the acoustic control device 1 according to the fourth embodiment. The operation in FIG. 9 is controlled by the processor 101. In the description of FIG. 9, a description of the same processing steps as those in FIG. 3, FIG. 5, or FIG. 7 will be omitted as appropriate.

In step S31, the processor 101 recognizes a situation in the space containing the system and collects information for determining whether or not to output the interference sound. A mechanism for implementing step S31 may or may not be contained in the system of the control device.

In step S32, the processor 101 determines whether output of the interference sound is necessary or not. In step S32, if it is not determined that output of the interference sound is necessary, the processing proceeds to step S37. In step S32, if it is determined that output of the interference sound is necessary, the processing proceeds to step S33.

In step S33, the processor 101 generates the interference sound data. For example, the processor 101 acquires the interference sound data from the storage 103.

In step S34, the processor 101 changes a localization direction of the interference sound data. Specifically, the processor 101 instructs the acoustic processing circuit 104 to change a filter to be applied for the sound image localization processing. Changing of a filter is performed by continuously or randomly selecting filters corresponding to different localization directions, along a predetermined trajectory.

In step S35, the processor 101 causes the acoustic processing circuit 104 to perform the sound image localization processing on the interference sound data using the localization direction changed in step S34. The acoustic processing circuit 104 generates the L channel interference sound data and the R channel interference sound data by applying the changed filter to the interference sound data. Then, in step S36, the acoustic processing circuit 104 reproduces the L channel interference sound data from the speaker 105a, and reproduces the R channel interference sound data from the speaker 105b.

In step S37, the processor 101 determines whether or not to terminate the operation in FIG. 9. In step S37, if it is not determined that the operation in FIG. 9 is to be terminated, the processor 101 returns the processing to step S32. If it is determined in step S37 that the operation in FIG. 9 is to be terminated, the processor 101 terminates the operation in FIG. 9.

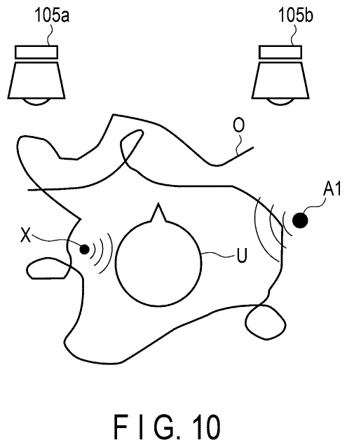

As described above, according to the fourth embodiment, the sound image localization processing for different localization directions is performed on the same interference sound data, as processing to be performed on the interference sound. As shown in FIG. 10, this generates a state in which the listener U is in the center of a space where he or she hear sounds as if the sound source A1 is moving around him or her along the trajectory O, which is a rare occurrence in normal listening situations. By this, the listener U's consciousness is more directed toward the interference sound, and as a result, hearing of the target sound from the target sound source X, to which the listener U is trying to listen, may be hindered.

Herein, in the example of FIG. 10, the sound image localization processing is performed on one piece of interference sound data. On the other hand, in the fourth embodiment, sound image localization processing for sequentially changing the localization direction may be performed on a plurality of pieces of interference sound data. In this case, the acoustic processing circuit 104 mixes the respective pieces of acoustic sound data on which the sound image localization processing has been performed, and reproduces the resultant data from the speakers 105a and 105b.

Furthermore, in the fourth embodiment, the volume adjustment processing and the frequency band adjustment processing may be performed on the respective pieces of interference sound data.

### Fifth Embodiment

Next, a fifth embodiment will be described. Herein, in the fifth embodiment, a description of similar parts to those in the first to fourth embodiments will be omitted. That is, the basic functional blocks shown in FIG. 1 can be applied to the fifth embodiment as well. The hardware configuration shown in FIG. 4 is basically applicable to a hardware configuration of the acoustic control device 1 according to the fifth embodiment. However, in the fifth embodiment, the speakers 105a and 105b operate as sound sources for reproducing the counter sound data rather than the interference sound data. The counter sound data is data containing information on a counter sound intended for a listener to hear as a counter against a target sound, not a sound that interferes with hearing of the target sound. The counter sound is, for example, a sound that contains a message to attract the listener's attention. Therefore, in the fifth embodiment, the sound acquisition unit 10 acquires the counter sound data instead of the interference sound data.

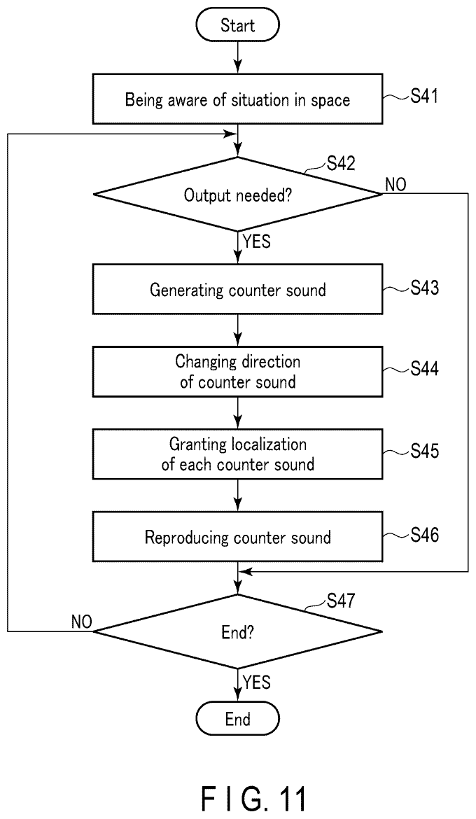

Next, the operation of the acoustic control device 1 according to the fifth embodiment will be described. FIG. 11 is a flowchart showing the operation of the acoustic control device 1 according to the fifth embodiment. The operation in FIG. 11 is controlled by the processor 101. In the description of FIG. 11, a description of the same processing steps as those in FIG. 3, FIG. 5, FIG. 7, or FIG. 9 will be omitted as appropriate.

In step S41, the processor 101 recognizes a situation in the space containing the system and collects information for determining whether or not to output the counter sound. A situation in the space containing the system concerned is recognized, and information for determination as to whether or not to output the counter sound is collected. A mechanism for implementing step S41 may or may not be contained in the system of the control device.

In step S42, the processor 101 determines whether output of the counter sound is necessary or not. In step S42, if it is not determined that output of the counter sound is necessary, the processing proceeds to step S47. In step S42, if it is determined that output of the counter sound is necessary, the processing proceeds to step S43.

In step S43, the processor 101 generates the counter sound data. For example, the processor 101 acquires the interference sound data from the storage 103.

In step S44, the processor 101 changes a localization direction of the counter sound data. Specifically, the processor 101 instructs the acoustic processing circuit 104 to change a filter to be applied for the sound image localization processing. Changing of a filter is performed by continuously or randomly selecting filters corresponding to different localization directions, along a predetermined trajectory. Herein, the counter sound data is sound data the contents of which are intended to be heard by a listener. Therefore, it is desirable that the amount of change in the localization direction of counter sound data be smaller than the amount of change in the localization direction of interference sound data.

In step S45, the processor 101 causes the acoustic processing circuit 104 to perform sound image localization processing on the counter sound data using the localization direction changed in step S44. The acoustic processing circuit 104 generates counter sound data for the L channel (hereinafter referred to as “L channel counter sound data”) and counter sound data for the R channel (hereinafter referred to as “R channel counter sound data”) by applying the changed filter to the counter sound data. In step S46, the acoustic processing circuit 104 reproduces the L channel counter sound data from the speaker 105a, and also reproduces the R channel counter sound data from the speaker 105b.

In step S47, the processor 101 determines whether or not to terminate the operation in FIG. 11. In step S47, if it is not determined that the operation in FIG. 11 is to be terminated, the processor 101 returns the processing to step S42. If it is determined in step S47 that the operation in FIG. 11 is to be terminated, the processor 101 terminates the operation in FIG. 11.

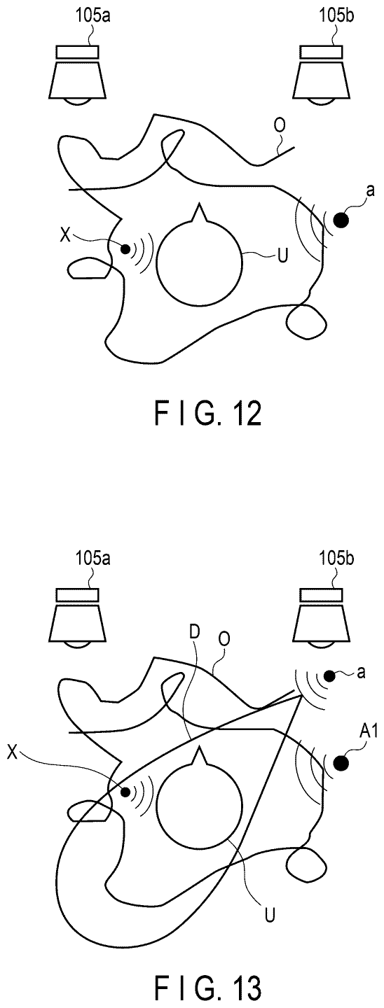

As described above, according to the fifth embodiment, the sound image localization processing in different localization directions is performed on the same counter sound data, as processing to be performed on the counter sound. As shown in FIG. 12, this generates a state in which the listener U is in the center of a space where he or she hears sounds as if the counter sound source a is moving around him or her along the trajectory O, which is a rare occurrence in normal listening situations. By this, the listener U's consciousness is more directed toward the counter sound, and as a result, hearing of the target sound from the target sound source X, to which the listener U is trying to listen, may be hindered.

Herein, in the fifth embodiment, the volume adjustment processing and the frequency band adjustment processing may be performed on the counter sound data. Furthermore, the counter sound is a sound intended for the listener U to hear. Therefore, the counter sound may be given directivity toward the listener U. For example, if there are three or more speakers, directivity is imparted by, for example, area sound pressure control, which is a combination of acoustic power control and phase delay control.

### Modification of Fifth Embodiment

A modification of the fifth embodiment will be described. The fifth embodiment described the example in which the sound image localization is performed on counter sound data, instead of interference sound data, and the counter sound data is then reproduced. On the other hand, as shown in FIG. 13, in addition to the counter sound source a, the interference sound source Al may also be localized and reproduced as a sound image. The sound image localization of the interference sound source Al may be performed using any of the methods described in the second to fourth embodiments. FIG. 13 shows an example in which the sound image localization of the interference sound source A1 is performed by the method described in the fourth embodiment. Simultaneous reproduction of the interference sound and the counter sound further enhances the effect of hindering the listener U from listening to the target sound from the target sound source X, to which the listener U is trying to listen.

Herein, the interference sound is a sound that serves as noise to the listener U, whereas the counter sound is a sound intended for the listener U to hear. Simultaneous reproduction of the interference sound and the counter sound leads to a possibility that the interference sound will interfere with hearing of the counter sound. Therefore, in the modification of the fifth embodiment, it is more desirable that the counter sound source a be given a directivity D toward the listener U as shown in FIG. 13. For example, if there are three or more speakers, directivity D is imparted by, for example, area sound pressure control which is a combination of acoustic power control and phase delay control.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An acoustic control device comprising a processor including hardware configured to:
acquire interference sound data containing information on an interference sound that serves as noise for interfering with hearing of a target sound to which a lister is listening;
perform acoustic processing for interfering with the hearing of the target sound on the acquired interference sound data; and
reproduce, through an output device, the interference sound data on which the acoustic processing has been performed.

2. The acoustic control device according to claim 1, wherein the processor performs, as the acoustic processing, at least one of adjustment processing of a volume in the interference sound data, adjustment processing of a frequency band, or sound image localization processing of the interference sound data.

3. The acoustic control device according to claim 1, wherein the processor is configured to:
copy the interference sound data; and
impart different phases and perform sound image localization processing in different directions with respect to a plurality of copies of the interference sound data, obtained through copying.

4. The acoustic control device according to claim 1, wherein
the processor sequentially performs sound image localization processing in different directions with respect to same interference sound data.

5. An acoustic control device comprising a processor including hardware configured to:
acquire counter sound data containing content to which a listener is caused to listen as a counter against a target sound;
perform acoustic processing for interfering with hearing of a target to which a listener is listening on the acquired counter sound data; and
reproduce, through an output device, the counter sound data on which the acoustic processing has been perform.

6. The acoustic control device according to claim 5, wherein the processor performs, as the acoustic processing, at least one of adjustment processing of a volume in the counter sound data, adjustment processing of a frequency band, or sound image localization processing of the counter sound data.

7. The acoustic control device according to claim 5, wherein the processor further performs processing of imparting directivity for the listener to the counter sound data.

8. An acoustic control device comprising a processor including hardware configured to:
acquire interference sound data containing information on an interference sound that serves as noise for interfering with hearing of a target sound to which a lister is listening, and counter sound data containing a content to which a listener is caused to listen as a counter against the target sound;
perform acoustic processing for interfering with the hearing of the target sound on the interference sound data and the counter sound data both acquired; and
reproduce, through an output device, the interference sound data and the counter sound data on each of which the acoustic processing has been performed.
